(19) United States
(12) Patent Application Publication
(10) Pub. No.: US 2020/0077414 A1
(43) Pub. Date: Mar. 5, 2020

(54) CHANNEL QUALITY INDICATOR TABLE DESIGN FOR WIDEBAND COVERAGE ENHANCEMENT IN MULTEFIRE SYSTEMS

(71) Applicant: Intel IP Corporation, Santa Clara, CA (US)

(72) Inventors: Qiaoyang Ye, San Jose, CA (US); Huaning Niu, San Jose, CA (US); Wenting Chang, Beijing (CN); Salvatore Talarico, Sunnyvale, CA (US)

(21) Appl. No.: 16/493,739

(22) PCT Filed: Mar. 9, 2018
(86) PCT No.: PCT/US18/21836

§ 371 Date: Sep. 12, 2019

Related U.S. Application Data
(60) Provisional application No. 62/528,778, filed on Jul. 5, 2017.
(60) Provisional application No. 62/473,112, filed on Mar. 17, 2017.

(51) Int. Cl. H04W 72/08; H04W 16/26; H04W 72/04; H04L 5/00

(52) U.S. Cl. CPC H04W 72/085; H04W 16/26; H04W 88/04; H04L 5/0057; H04W 72/048

(57) ABSTRACT

Technology for a user equipment (UE) operable to report channel quality indication (CQI) information to a Next Generation NodeB (gNB) in a wideband coverage enhancement (WCE) for MulteFire system is disclosed. The UE can decode a coding rate scaling factor received from the gNB in the WCE for MulteFire system. The UE can measure a channel between the gNB and the UE. The UE can calculate a modulation and coding rate based on the channel measurement between the gNB and the UE. The UE can scale the modulation and coding rate using the coding rate scaling factor to form a scaled modulation and coding rate. The UE can select a CQI index that corresponds to the scaled modulation and coding rate. The UE can encode the CQI index for transmission to the gNB in a channel state information (CSI) report.

### BACKGROUND

Wireless systems typically include multiple User Equipment (UE) devices communicatively coupled to one or more Base Stations (BS). The one or more BSs may be Long Term Evolved (LTE) evolved NodeBs (eNB) or New Radio (NR) next generation NodeBs (gNB) that can be communicatively coupled to one or more UEs by a Third-Generation Partnership Project (3GPP) network.

Next generation wireless communication systems are expected to be a unified network/system that is targeted to meet vastly different and sometimes conflicting performance dimensions and services. New Radio Access Technology (RAT) is expected to support a broad range of use cases including Enhanced Mobile Broadband (eMBB), Massive Machine Type Communication (mMTC), Mission Critical Machine Type Communication (uMTC), and similar service types operating in frequency ranges up to 100 GHz.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 is a 4-bit channel quality information (CQI) table for Release 13 (Rel-13) enhanced Machine Type Communication (eMTC) systems in accordance with an example;

FIG. 2 is a 4-bit channel quality information (CQI) table for legacy Long Term Evolution (LTE) systems in accordance with an example;

FIGS. 3A and 3B are 4-bit channel quality information (CQI) tables that do not support 64 quadrature amplitude modulation (64 QAM) for Wideband Coverage Enhancement (WCE) MulteFire systems in accordance with an example;

FIGS. 4A and 4B are 4-bit channel quality information (CQI) tables that support 64 quadrature amplitude modulation (64 QAM) for Wideband Coverage Enhancement (WCE) MulteFire systems in accordance with an example;

FIG. 5 is a table with a set of possible entries to be added to an existing channel quality information (CQI) table in accordance with an example;

FIGS. 6A, 6B and 6C are 4-bit channel quality information (CQI) tables with quadrature phase shift keying (QPSK) and 16 quadrature amplitude modulation (16 QAM) for Wideband Coverage Enhancement (WCE) MulteFire systems in accordance with an example;

FIG. 7 illustrates signaling between a user equipment (UE) and a Next Generation NodeB (gNB) for channel quality information (CQI) reporting in accordance with an example;

FIG. 8 depicts functionality of a user equipment (UE) operable to report channel quality indication (CQI) information to a Next Generation NodeB (gNB) in a wideband coverage enhancement (WCE) for MulteFire system in accordance with an example;

FIG. 9 depicts functionality of a Next Generation NodeB (gNB) operable to decode channel quality indication (CQI) information received from a user equipment (UE) in a wideband coverage enhancement (WCE) for MulteFire system in accordance with an example;

FIG. 10 depicts a flowchart of a machine readable storage medium having instructions embodied thereon for reporting channel quality indication (CQI) information from a user equipment (UE) to a Next Generation NodeB (gNB) in a wideband coverage enhancement (WCE) for MulteFire system in accordance with an example;

FIG. 11 illustrates an architecture of a wireless network in accordance with an example;

FIG. 12 illustrates a diagram of a wireless device (e.g., UE) in accordance with an example;

FIG. 13 illustrates interfaces of baseband circuitry in accordance with an example; and

FIG. 14 illustrates a diagram of a wireless device (e.g., UE) in accordance with an example.

Reference will now be made to the exemplary embodiments illustrated, and specific language will be used herein to describe the same. It will nevertheless be understood that no limitation of the scope of the technology is thereby intended.

### DETAILED DESCRIPTION

Before the present technology is disclosed and described, it is to be understood that this technology is not limited to the particular structures, process actions, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating actions and operations and do not necessarily indicate a particular order or sequence.

### Definitions

As used herein, the term “User Equipment (UE)” refers to a computing device capable of wireless digital communication such as a smart phone, a tablet computing device, a laptop computer, a multimedia device such as an iPod Touch®, or other type computing device that provides text or voice communication. The term “User Equipment (UE)” may also be refer to as a “mobile device,” “wireless device,” of “wireless mobile device.”

As used herein, the term “Base Station (BS)” includes “Base Transceiver Stations (BTS),” “NodeBs,” “evolved NodeBs (eNodeB or eNB),” and/or “next generation NodeBs (gNodeB or gNB),” and refers to a device or configured node of a mobile phone network that communicates wirelessly with UEs.

As used herein, the term “cellular telephone network,” “4G cellular,” “Long Term Evolved (LTE),” “5G cellular” and/or “New Radio (NR)” refers to wireless broadband technology developed by the Third Generation Partnership Project (3GPP).

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

The present technology relates to Long Term Evolution (LTE) operation in an unlicensed spectrum in MulteFire, and specifically the wideband coverage enhancement (WCE) for MulteFire systems. More specifically, the present technology relates to a design for channel state information (CSI) measurements and a channel quality indicator (CQI) table for the WCE for MulteFire systems.

In one example, Internet of Things (IoT) is envisioned as a significantly important technology component, by enabling connectivity between many devices. IoT has wide applications in various scenarios, including smart cities, smart environment, smart agriculture, and smart health systems.

3GPP has standardized two designs to IoT services—enhanced Machine Type Communication (eMTC) and NarrowBand IoT (NB-IoT). As eMTC and NB-IoT UEs will be deployed in large numbers, lowering the cost of these UEs is a key enabler for the implementation of IoT. Also, low power consumption is desirable to extend the life time of the UE's battery.

With respect to LTE operation in the unlicensed spectrum, both Release 13 (Rel-13) eMTC and NB-IoT operates in a licensed spectrum. On the other hand, the scarcity of licensed spectrum in low frequency band results in a deficit in the data rate boost. Thus, there are emerging interests in the operation of LTE systems in unlicensed spectrum. Potential LTE operation in the unlicensed spectrum includes, but not limited to, Carrier Aggregation based licensed assisted access (LAA) or enhanced LAA (eLAA) systems, LTE operation in the unlicensed spectrum via dual connectivity (DC), and a standalone LTE system in the unlicensed spectrum, where LTE-based technology solely operates in the unlicensed spectrum without necessitating an “anchor” in licensed spectrum—a system that is referred to as MulteFire.

In one example, there are substantial use cases of devices deployed deep inside buildings, which would necessitate coverage enhancement in comparison to the defined LTE cell coverage footprint. In summary, eMTC and NB-IoT techniques are designed to ensure that the UEs have low cost, low power consumption and enhanced coverage.

To extend the benefits of LTE IoT designs into unlicensed spectrum, MulteFire 1.1 is expected to specify the design for Unlicensed-IoT (U-IoT) based on eMTC and/or NB-IoT. The unlicensed frequency band of current interest for NB-IoT or eMTC based U-IoT is the sub-1 GHz band and the ˜2.4 GHz band.

In addition, different from eMTC and NB-IoT which applies to narrowband operation, the WCE is also of interest to MulteFire 1.1 with an operation bandwidth of 10 MHz and 20 MHz. The objective of WCE is to extend the MulteFire 1.0 coverage to meet industry IoT market specifications, with the targeting operating bands at 3.5 GHz and 5 GHz.

In Rel-13 eMTC, CSI measurement and feedback can be supported only in coverage enhancement (CE) mode A. In other words, in Rel-13 eMTC, there is no support of CSI feedback in a large coverage enhancement. As time-domain repetition is introduced to eMTC for coverage enhancement, it is desirable to update the channel quality indicator (CQI) table to incorporate the impact from time domain repetitions.

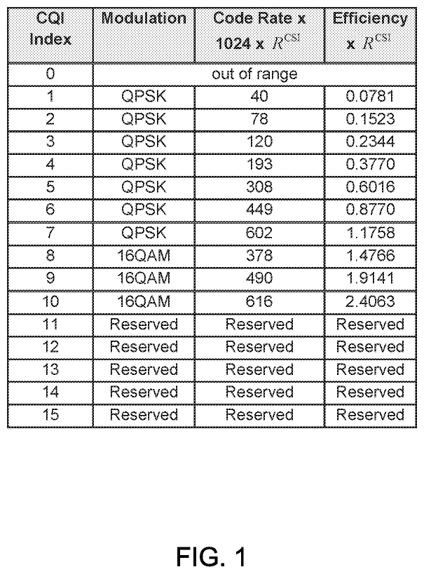

FIG. 1 is an example of a 4-bit CQI table for Rel-13 eMTC systems. The CQI table for Rel-13 eMTC can include, for a given CQI index, a modulation scheme, a code rate×1024×R^{CSI}, and a spectral efficiency×R^{CSI}. The CQI index can range from 0 to 15. The modulation scheme can be quadrature phase shift keying (QPSK) or 16 quadrature amplitude modulation (16 QAM). In this example, R^{CSI} can be given by a higher layer parameter CSI number repetition CE (csi-NumRepetitionCE), which can indicate a number of subframes for a CSI reference resource. The R^{CSI} can be UE-specific with a value from set {1, 2, 4, 8, 16, 32, reserved}. When R^{CSI} is equal to 1, no repetition for a physical downlink shared channel (PDSCH) is allowed. On the other hand, when R_{CSI} is greater than 1 (i.e., R^{CSI}>1), PDSCH repetitions can be allowed.

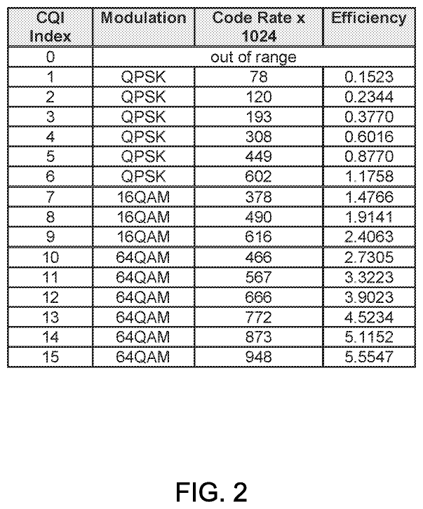

FIG. 2 is an example of a 4-bit CQI table for legacy LTE systems. The CQI table for legacy LTE can include, for a given CQI index, a modulation scheme, a code rate×1024, and a spectral efficiency value. The CQI index can range from 0 to 15. The modulation scheme can be quadrature phase shift keying (QPSK), 16 QAM or 64 QAM.

In one example, the CQI table for Rel-13 eMTC (as shown in FIG. 1) can include a new entry with QPSK and a code rate×1024×R^{CSI} that is equal to 40, as compared to the CQI table for legacy LTE (as shown in FIG. 2). The new entry with QPSK and the code rate×1024×R^{CSI} that is equal to 40 can support a lower code rate. In addition, the CQI table for Rel-13 eMTC does not include 64 QAM entries, as compared to the CQI table for legacy LTE, as Rel-13 eMTC does not support 64 QAM.

In one example, similar to Rel-13 eMTC, MulteFire 1.1 WCE can adopt time domain repetitions for coverage enhancement. In addition, as WCE is not bandwidth limited, a frequency domain enhancement can also be adopted. For example, a transport block size (TBS) can be scaled to lower a code rate. Alternatively, frequency domain repetition can be used, which can effectively produce a lower code rate. Besides the frequency domain enhancement, power boosting can be used, e.g., for resource elements (REs) carrying data in the PDSCH and demodulation reference signals (DMRS) in an enhanced physical downlink control channel (ePDCCH).

In one example, similar to Rel-13 eMTC, a new CQI table is desired for the MulteFire WCE, which can incorporate the time domain repetitions, TBS scaling, frequency domain repetitions and/or power boosting.

In the present technology, a CQI table design for the WCE in MulteFire 1.1 is described. In a first alternative, the LTE CQI table or Rel-13 eMTC CQI table can be reused by adding the scaling factor in the code rate and spectral efficiency columns. In a second alternative, new entries can be added to the LTE CQI table or Rel-13 eMTC CQI table, which can take into account TBS scaling and/or time/frequency repetitions.

In one configuration, when designing the CQI table for the WCE in MulteFire 1.1, the LTE CQI table or Rel-13 eMTC CQI table can be reused by adding the scaling factor in the code rate and spectral efficiency columns. In other words, in this configuration, the entries in the existing LTE CQI table or Rel-13 eMTC CQI table can be reused. To incorporate the impact from time domain repetitions, TBS scaling/frequency domain repetitions, the column description of “code rate×1024” and “spectral efficiency” can be modified to “code rate×1024×R” and “spectral efficiency×R”, where R (also referred to as a coding rate scaling factor) can depend on a number of time domain repetitions, a TBS scaling factor/number of frequency domain repetitions and/or a power boosting factor.

In one example, when designing the CQI table for the WCE in MulteFire 1.1, 64 QAM may not be supported in the WCE, which case entries in the CQI table for 64 QAM can be reserved. Alternatively, when designing the CQI table for the WCE in MulteFire 1.1, 64 QAM can be supported in the WCE, in which case entries corresponding to 64 QAM in LTE can be kept.

In one configuration, the value of R can be a function of Rₜᵢₘₑ, R_{freq} and P_{b}, e.g., R=Rₜᵢₘₑ*R_{freq}*10\hat{ }(P_{b}/10), where Rₜᵢₘₑ can indicate the number of time domain repetitions, R_{freq} can indicate the TBS scaling/frequency domain repetitions, and P_{b} can indicate the power boosting factor (in decibels, or dB).

In one configuration, the value of R (or the values of Rₜᵢₘₑ, R_{freq} and/or P_{b} that can be used to derive R) can be configured using a number of mechanisms. In a first option, the value of R can be semi-statically configured using radio resource control (RRC) signaling. R can be cell-specific or UE-specific. The parameter of CSI number of repetitions (csi-NumRepetition), which can indicate the number of subframes for a CSI reference resource, can be configured together with an ePDCCH configuration for WCE UEs. The csi-NumRepetition can take one or multiple values from {sf1, sf2, sf4, sf8, sf16, sf32}. In a second option, the value of R can be based on a value used for a latest PDSCH transmission for the UE. In a third option, the value of R can be defined based on a function from an (e)PDCCH aggregation level. For example, with a larger (e)PDCCH aggregation level, the value of R (e.g., Rₜᵢₘₑ and/or R_{freq} and/or P_{b}) can be increased. In a fourth option, the value of P_{b} can be based on the power boosting factor used for a DMRS in a latest ePDCCH transmission. In addition, the value of R (or the values of Rₜᵢₘₑ, R_{freq} and/or P_{b} that can be used to derive R) can be configured using a combination of the four options described.

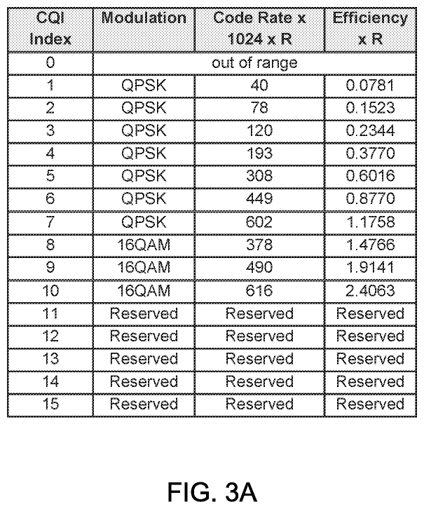

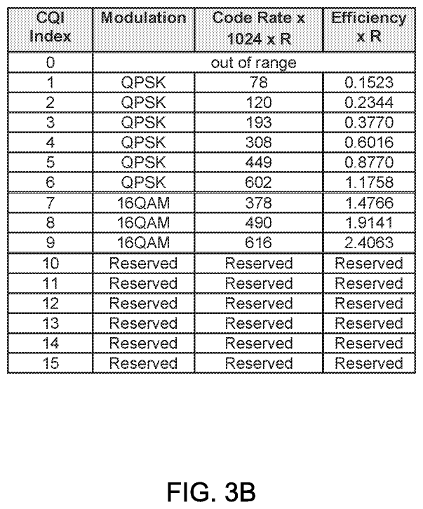

FIG. 3A is an example of a 4-bit CQI table that does not support 64 QAM for WCE MulteFire systems. In this case, since 64 QAM is not supported in the WCE, entries for 64 QAM can be reserved. In this example, the CQI table for the WCE when 64 QAM is not supported can include, for a given CQI index, a modulation scheme, a code rate×1024×R, and a spectral efficiency×R. The CQI index can range from 0 to 15. The modulation scheme can be QPSK or 16 QAM. In this example, the CQI table for the WCE can include an entry with QPSK and a code rate×1024×R that is equal to 40 to support a lower code rate. In addition, R can depend on time domain repetitions, a TBS scaling factor/frequency domain repetitions and/or a power boosting factor.

FIG. 3B is an example of a 4-bit CQI table that does not support 64 QAM for WCE MulteFire systems. In this case, since 64 QAM is not supported in the WCE, entries for 64 QAM can be reserved. In this example, the CQI table for the WCE when 64 QAM is not supported can include, for a given CQI index, a modulation scheme, a code rate×1024×R, and a spectral efficiency×R. The CQI index can range from 0 to 15. The modulation scheme can be QPSK or 16 QAM. In this example, unlike the CQI table shown in FIG. 3A, the CQI table for the WCE does not include an entry with QPSK and a code rate×1024×R that is equal to 40 to support a lower code rate. In addition, R can depend on time domain repetitions, a TBS scaling factor/frequency domain repetitions and/or a power boosting factor.

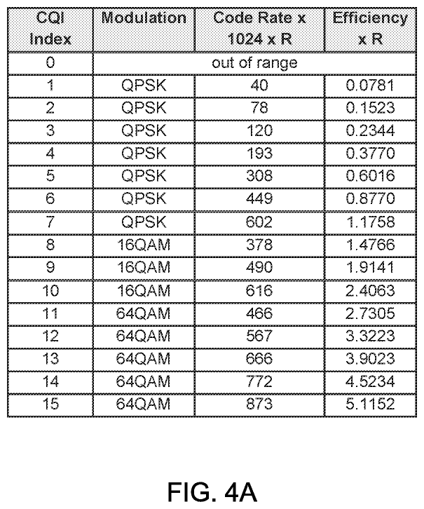

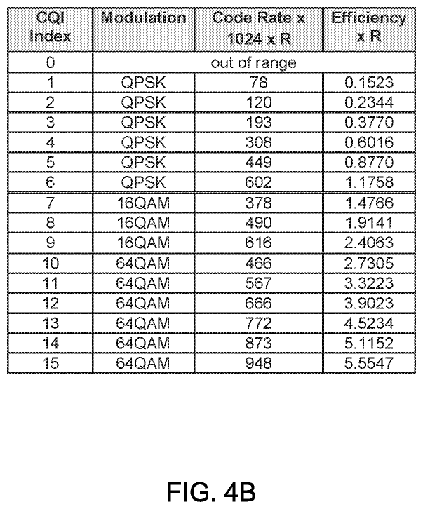

FIG. 4A is an example of a 4-bit CQI table that supports 64 QAM for WCE MulteFire systems. In this example, the CQI table for the WCE when 64 QAM is supported can include, for a given CQI index, a modulation scheme, a code rate×1024×R, and a spectral efficiency×R. The CQI index can range from 0 to 15. The modulation scheme can be QPSK, 16 QAM or 64 QAM. In this example, the CQI table for the WCE can include an entry with QPSK and a code rate×1024×R that is equal to 40 to support a lower code rate. In addition, R can depend on time domain repetitions, a TBS scaling factor/frequency domain repetitions and/or a power boosting factor.

FIG. 4B is an example of a 4-bit CQI table that supports 64 QAM for WCE MulteFire systems. In this example, the CQI table for the WCE when 64 QAM is supported can include, for a given CQI index, a modulation scheme, a code rate×1024×R, and a spectral efficiency×R. The CQI index can range from 0 to 15. The modulation scheme can be QPSK, 16 QAM or 64 QAM. In this example, unlike the CQI table shown in FIG. 4A, the CQI table for the WCE does not include an entry with QPSK and a code rate×1024×R that is equal to 40 to support a lower code rate. In addition, R can depend on time domain repetitions, a TBS scaling factor/frequency domain repetitions and/or a power boosting factor.

In one configuration, when designing the CQI table for the WCE in MulteFire 1.1, new entries can be added to the LTE CQI table or Rel-13 eMTC CQI table, which can take into account TBS scaling and/or time/frequency repetitions. In other words, in this configuration, new entries can be added to the existing LTE CQI table or Rel-13 eMTC CQI table. In general, an integer between 1 to 77 in the column “code rate×1024” and corresponding spectral efficiency can be added. In this example, one or multiple new entries can be added to the existing LTE CQI table or Rel-13 eMTC CQI table.

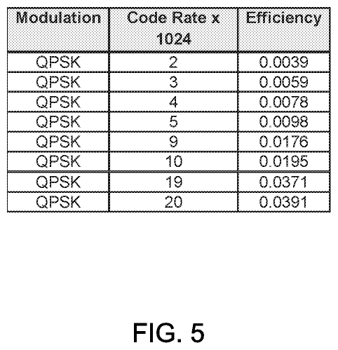

FIG. 5 is an exemplary table with a set of possible entries to be added to an existing CQI table. In this example, for a given modulation scheme (e.g., QPSK), a code rate×1024 and a spectral efficiency value can be defined.

In one configuration, a 4-bit CQI table for the WCE can be utilized, which can include QPSK and 16 QAM, and new entries with a lower code rate can be introduced. For example, a UE can be RRC configured to operate in normal coverage and in a WCE mode. When the UE operates in the normal coverage, the CQI table can follow MulteFire 1.0. On the other hand, when the UE is configured to operate in the WCE mode, the 4-bit CQI table for WCE with QPSK and 16 QAM and the new entries with the lower code rate can be used.

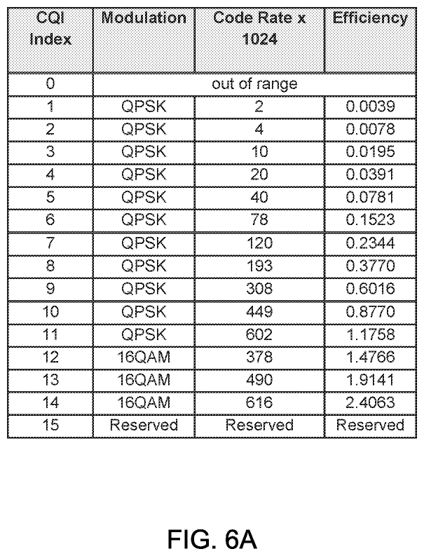

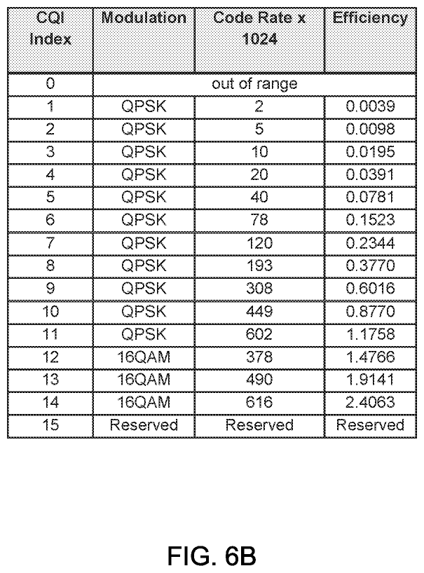

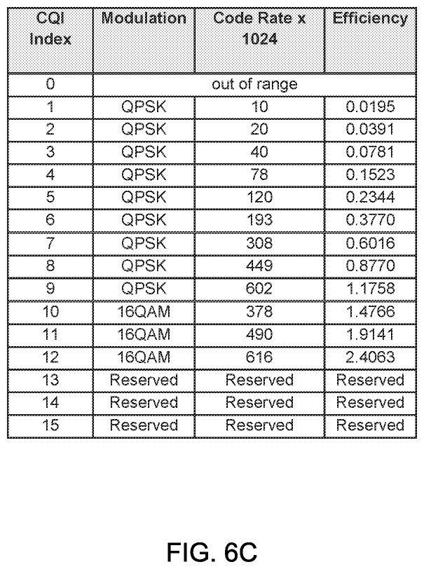

FIGS. 6A, 6B and 6C are examples of a 4-bit CQI table with QPSK and 16 QAM for WCE MulteFire systems. The CQI tables can include new entries with lower code rates. In these examples, the CQI tables with QPSK and 16 QAM can include, for a given CQI index, a modulation scheme (e.g., QPSK or 16 QAM), a code rate×1024, and a spectral efficiency value. The CQI index can range from 0 to 15.

In one example, the CQI tables shown in FIGS. 6A and 6B can be applied to cases where the number of repetitions of the PDSCH can be up to 32. In another example, the CQI table shown in FIG. 6C can be applied to cases with a smaller number of time domain repetitions, power boosting factor, and/or TBS scaling/frequency domain repetitions, e.g., up to 8 repetitions.

In one example, an additional set of CQI can be selected according to a criteria which accounts for the existing tradeoff between energy efficiency and/or complexity versus spectral efficiency. In addition, the same criteria can also be used to redesign the whole CQI table.

In one configuration, various options for channel measurement can be defined. For example, a first option for the channel measurement can involve an open loop measurement, a second option can involve a measurement based on a channel state information reference signal (CSI-RS), a third option can involve a measurement based on a cell specific reference signal (CRS), and a fourth option can involve a measurement based on hybrid reference signals (RS).

In one example, with respect to the first option that involves the open loop measurement, an open loop link adaption can be supported. For instance, an eNodeB can measure a channel quality based on an uplink sounding reference signal (SRS). The eNodeB can estimate a link quality of a UE. The eNodeB can select the UE's working mode. The eNodeB can assign a corresponding CQI and/or modulation and coding scheme (MCS). In addition, as the transmission is occurring, the eNodeB can adjust the CQI/MCS according to acknowledgement or negative acknowledgement (ACK/NACK) feedback from the UE.

In one example, with respect to the second option that involves the measurement based on a CSI-RS, the CSI-RS can be utilized, e.g., for beam formed channel measurement and larger antenna ports. The measurement based on the CSI-RS can be enhanced in the time domain and/or the frequency domain.

In one configuration, the measurement based on the CSI-RS can be improved in the time domain. In legacy LTE, the minimal CSI-RS period is 5 milliseconds (ms). To increase the density of the CSI-RS in order to improve CSI measurement accuracy, a smaller period can be introduced. For example, an additional period of 1, 2, 3, and/or 4 ms can be introduced. Alternatively, time domain repetitions can be introduced for the CSI-RS. Some legacy CSI-RS configurations can be reused to define one CSI-RS instance benchmark. The remaining CSI-RS repetitions can be transmitted in the OFDM symbols or subframes, before or after the instance benchmark. For instance, with two repetitions, the additional CSI-RS can be transmitted in the OFDM symbol 12/13, or 2/3 in the same subframe as the benchmark (reference) configuration, and so on. When an additional CSI-RS is configured at the symbols where a CRS is transmitted, resource elements (REs) that exclude the CRS can be utilized for the CSI-RS transmission, in order to be compatible with legacy UEs.

In another configuration, the measurement based on the CSI-RS can be improved in the frequency domain. For example, new CSI-RS ports can be defined, which are compatible with legacy CSI-RS REs for backward compatibility. For instance, a new CSI-RS port can contain CSI-RS REs of legacy CSI-RS ports 15/16 and 17/18. The CSI-RS parameters of new CSI-RS port can be configured by high layer signaling. In addition, multiple legacy CSI-RS ports can be virtualized into one combined CSI-RS port. The number of legacy CSI-RS ports can be configured by high layer signaling. For instance, an eNodeB can configure the CSI-RS in a legacy manner with one additional CSI-RS port combination number N_{CSI,comb}, and then N_{CSI,comb} adjacent CSI-RS ports can be virtualized into one combined CSI-RS port.

In one example, the first and second options for channel measurement that involve the open loop measurement and the measurement based on the CSI-RS, respectively, can be utilized on top of power boosting, which is supported in current systems.

In one example, with respect to the third option that involves the measurement based on a CRS, the CRS can be utilized for channel estimation. A UE can detect the channel estimation by combining the CRS of multiple subframes.

In one example, with respect to the fourth option that involves the measurement based on hybrid REs, when not a beam formed channel measurement, in a larger antenna scenario, the CRS can be utilized for a 4 antenna measurement, while remaining ports can be measured based on the CSI-RS.

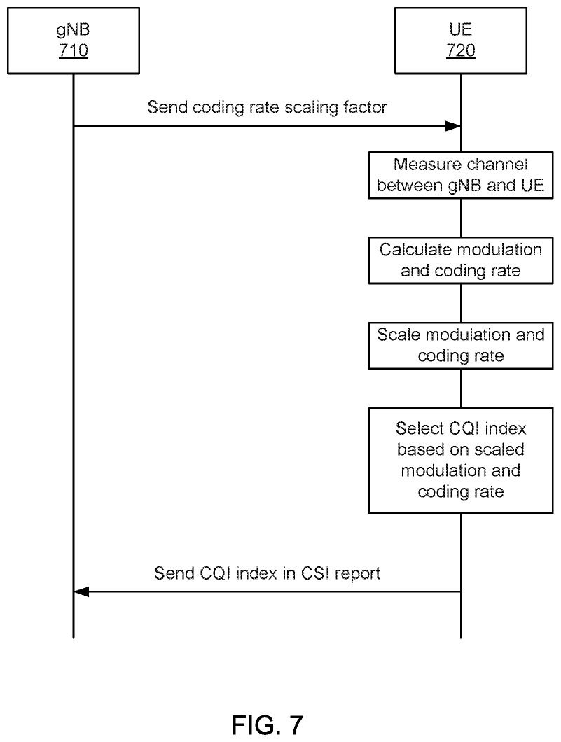

FIG. 7 illustrates exemplary signaling between a user equipment (UE) 720 and a Next Generation NodeB (gNB) 710 for channel quality information (CQI) reporting between the UE 720 and the gNB 710. The gNB 710 and the UE 720 can operate in a wideband coverage enhancement (WCE) for MulteFire system. The gNB 710 can transmit a coding rate scaling factor to the UE 720. The UE 720 can measure a channel between the gNB 710 and the UE 720. The UE 720 can calculate a modulation and coding rate based on the channel measurement between the gNB 710 and the UE 720. The UE 720 can scale the modulation and coding rate using the coding rate scaling factor to form a scaled modulation and coding rate. The UE 720 can select a CQI index that corresponds to the scaled modulation and coding rate. The UE 720 can transmit the CQI index in a channel state information (CSI) report to the gNB 710.

In one example, the UE 720 can receive the coding rate scaling factor from the gNB 710 via higher layer signaling between the gNB 710 and the UE 720. In another example, the UE 720 can select the CQI index using a CQI table. The CQI table an include a listing of CQI indexes, and for each CQI index, a modulation scheme, a modulation and coding rate multiplied by 1024 and the coding rate scaling factor, and a spectral efficiency value multiplied by the coding rate scaling factor. The modulation scheme can be one of: quadrature phase shift keying (QPSK), 16 quadrature amplitude modulation (16 QAM), or 64 QAM. The CQI table can include a CQI index that corresponds to QPSK, and a coding rate multiplied by 1024 and the coding rate scaling factor that is equal to 40. In addition, the coding rate scaling factor can be configured based on a number of time domain repetitions and transport block size (TBS) scaling. In other words, the coding rate scaling factor can account for the number of time domain repetitions and the TBS scaling used by the gNB 710 to enhance coverage.

In one configuration, the selection of the CQI values can be based upon channel measurements that the UE 720 performs over dedicated reference signals (i.e., CSI-RS), which can be received from the gNB 710. This selection is part of the link adaptation between the gNB 710 and the UE 720, and the CQI value can be selected in order to pick a best modulation and coding scheme (MCS) value that the gNB 710 will use to perform downlink transmissions. This value is selected such that the gNB 710 can transmit a given transport block (TB) at a highest achievable throughput (at a throughout or code rate which is closest to maximum achievable ones, also referred to as the Shannon capacity) considering that the downlink will be performed with certain time domain and TBS scaling (which are indicated to the UE 720 through RRC signaling via a factor alpha). After the UE 720 determines an optimal CQI value this is reported back to the gNB 710 within the CSI report, this optimal CQI value can be used by the gNB 710 for a subsequent DL transmission.

In one configuration, a CQI value is a CQI index that is selected by the UE 720, which is can be reported in an UL subframe dedicated for a CSI report. The UE 720 can select the CQI index from a CQI table (as shown in FIG. 4A), such that the modulation and coding rate can be the closest possible to an achievable rate, and the UE 720 can provide an indication of this value to the gNB 710 within a CSI report, which can occur in a specific transmission occurrence (subframe n). The value of the CQI index can indicate to the gNB 710 the modulation and coding rate to be used for subsequent DL transmissions. This process can be referred to as a link adaptation. Here, the UE 720 can measure a quality of the channel between the gNB 710 and the UE, 720 and the UE 720 can suggest to the gNB 710 how to transmit more reliably and at a higher throughput the data or control information. In this configuration, as compared to LTE-legacy, the DL transmission from the gNB 710 to the UE 720 can be enhanced through time-domain repetitions and TBS scaling, which can be accounted for when the UE 720 selects the CQI.

In one example, a CQI index, regardless if the system operated in LTE-legacy or WCE, can be selected between index 1 and 15 of a CQI table, such that a single physical downlink shared channel (PDSCH) transport block with a combination of modulation scheme and transport block size corresponding to the CQI index, and occupying a group of downlink physical resource blocks referred to as a CSI reference resource, can be received with a transport block error probability not exceeding 0.1.

In this configuration, the value of R can jointly take into account the time domain repetitions and TBS scaling that are applied to the DL in order to enhance coverage. The value of R can be provided to the UE 710 by the network through RRC signaling, so that the UE 720 can know the level of repetition (1, 2, 4, 8) and TBS scaling (0.1, 0.25, 0.5, 1) that the gNB 710 will use to perform transmission, and select the CQI value as a consequence. In this example, the specific value of time repetitions or TBS scaling may not be used, since either TBS scaling or the time domain repetition can be interpreted as a coding rate change from the gNB's perspective. Therefore, the CQI selection procedure can be similar to legacy LTE, but the code-rate that scales with time repetitions/TBS scaling and throughout can be scaled based on R, and not individually on each of them. The individual value of time repetitions and TBS scaling can be contained in a downlink control information (DCI) format 1A/1B/1C/1D, but may not be used for this purpose, and they are to be known at the UE 720 only when the UE 720 decodes the PDSCH/PDCCH from the gNB 710 (in fact the UE 720 can be aware of the size of the TB and how many times it is repeated in time so the UE 720 can perform combining across repetitions).

In one example, a technique for CSI measurement and CQI table design for MulteFire systems with coverage enhancement is described. In a first configuration, an LTE CQI table or Rel-13 eMTC CQI table can be extended. In this example, a column description of “code rate×1024” and “spectral efficiency” can be modified to “code rate×1024×R” and “spectral efficiency×R”, where R can depend on a time domain repetition, TBS scaling, frequency domain repetition, and/or power boosting. In one example, R can be a function of time repetitions factor multiplied by a frequency domain factor multiplied by 10\hat{ }(power boosting factor/10), where the frequency domain factor can be a TBS scaling factor or a frequency domain repetition number.

In one example, the time domain repetition, the TBS scaling factor, the frequency domain repetition number, and/or the power boosting factor can be semi-statically configured by higher layer signaling. In another example, the time domain repetition, the TBS scaling factor, the frequency domain repetition number, and/or the power boosting factor can be based on corresponding values used for a latest PDSCH transmission. In yet another example, the time domain repetition, the TBS scaling factor, the frequency domain repetition number, and/or the power boosting factor can be a function of an (e)PDCCH aggregation level. In a further example, the time domain repetition, the TBS scaling factor, the frequency domain repetition number, and/or the power boosting factor can be based on a power boosting factor used for DMRS in a latest ePDCCH transmission. In addition, elements for 64 QAM can be reserved when 64 QAM is not supported.

In a second configuration, new entries can be introduced to an LTE CQI table or a Rel-13 eMTC CQI table. In this example, one or multiple of integers between 1 to 77 in the column “code rate×1024” can be added, and corresponding spectral efficiency can be added to the column “spectral efficiency”. The added code rate can be approximately evenly spread, e.g., adding 2, 4, 10, 20 in “code rate×1024” to the existing CQI table.

In one example, a CSI measurement can be based on an open loop measurement, e.g., an eNB can measure a channel status based on an SRS and can indicate an MCS to a UE. In another example, the CSI measurement can be based on a CSI-RS. The CSI-RS can be enhanced in the time domain. In yet another example, a smaller CSI-RS periodicity can be introduced, e.g., 1, 2, 3, and/or 4 ms can be introduced as a new possible CSI-RS periodicity. In a further example, time domain repetitions can be introduced for the CSI-RS, where the CSI-RS can be repeated in other symbols in the same subframe, or can be repeated in following subframes. In yet a further example, the CSI-RS can be enhanced in the frequency domain.

In one example, new CSI-RS ports, using REs allocated for multiple existing CSI-RS ports can be introduced, e.g., a new CSI-RS port can use REs allocated for existing CSI-RS ports 15/16 and 17/18. In another example, multiple legacy CSI-RS ports can be virtualized into one combined CSI-RS port. New CSI-RS ports and new RE mapping from these ports can be defined. By supporting a fewer number of CSI-RS ports, the number of REs per port can be increased. In yet another example, power boosting can be adopted for the CSI-RS.

In one example, a CSI measurement can be based on a CRS. In another example, a CSI measurement can be based on hybrid RSs, e.g., the CRS can be used for a 4 antenna measurement and remaining ports can be measured based on the CSI-RS.

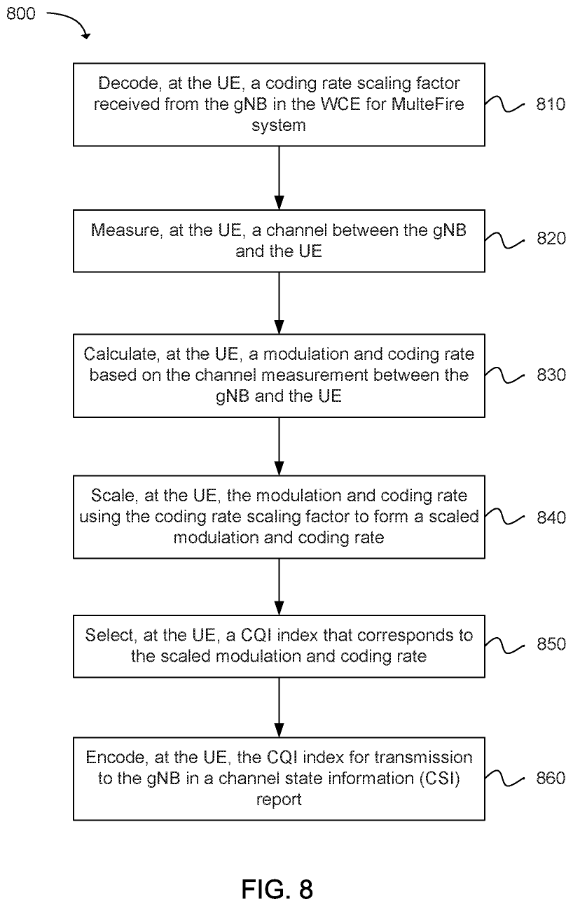

Another example provides functionality 800 of a user equipment (UE) operable to report channel quality indication (CQI) information to a Next Generation NodeB (gNB) in a wideband coverage enhancement (WCE) for MulteFire system, as shown in FIG. 8. The UE can comprise one or more processors configured to decode, at the UE, a coding rate scaling factor received from the gNB in the WCE for MulteFire system, as in block 810. The UE can comprise one or more processors configured to measure, at the UE, a channel between the gNB and the UE, as in block 820. The UE can comprise one or more processors configured to calculate, at the UE, a modulation and coding rate based on the channel measurement between the gNB and the UE, as in block 830. The UE can comprise one or more processors configured to scale, at the UE, the modulation and coding rate using the coding rate scaling factor to form a scaled modulation and coding rate, as in block 840. The UE can comprise one or more processors configured to select, at the UE, a CQI index that corresponds to the scaled modulation and coding rate, as in block 850. The UE can comprise one or more processors configured to encode, at the UE, the CQI index for transmission to the gNB in a channel state information (CSI) report, as in block 860. In addition, the UE can comprise a memory interface configured to send to a memory the coding rate scaling factor.

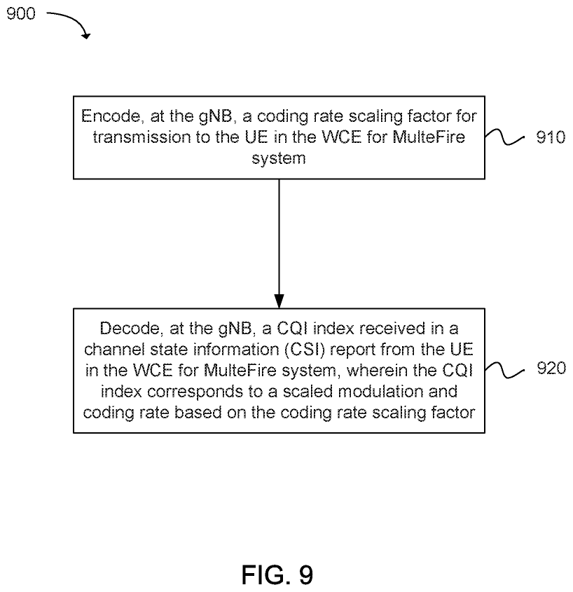

Another example provides functionality 900 of a Next Generation NodeB (gNB) operable to decode channel quality indication (CQI) information received from a user equipment (UE) in a wideband coverage enhancement (WCE) for MulteFire system, as shown in FIG. 9. The gNB can comprise one or more processors configured to encode, at the gNB, a coding rate scaling factor for transmission to the UE in the WCE for MulteFire system, as in block 910. The gNB can comprise one or more processors configured to decode, at the gNB, a CQI index received in a channel state information (CSI) report from the UE in the WCE for MulteFire system, wherein the CQI index corresponds to a scaled modulation and coding rate based on the coding rate scaling factor, as in block 920. In addition, the gNB can comprise a memory interface configured to send to a memory the CQI index received from the UE.

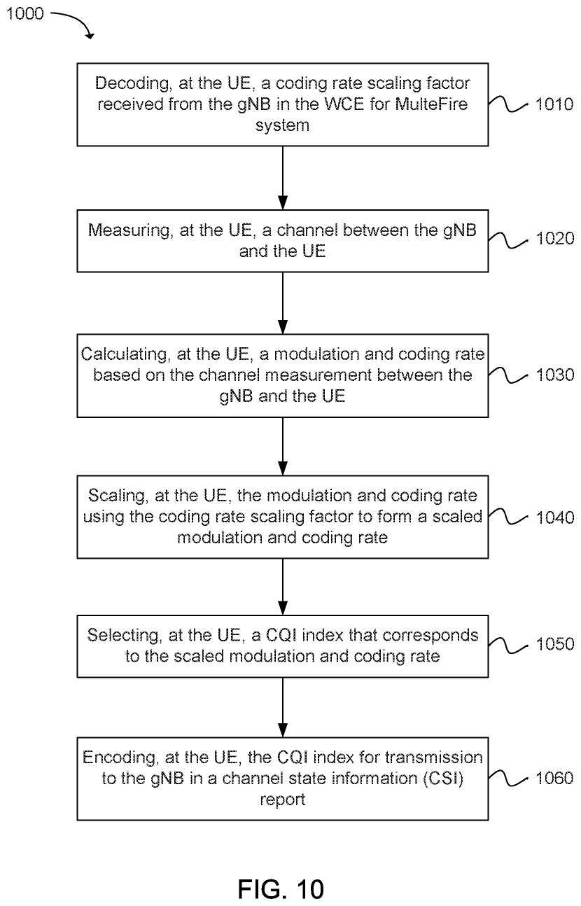

Another example provides at least one machine readable storage medium having instructions 1000 embodied thereon for reporting channel quality indication (CQI) information from a user equipment (UE) to a Next Generation NodeB (gNB) in a wideband coverage enhancement (WCE) for MulteFire system, as shown in FIG. 10. The instructions can be executed on a machine, where the instructions are included on at least one computer readable medium or one non-transitory machine readable storage medium. The instructions when executed by one or more processors of the UE perform: decoding, at the UE, a coding rate scaling factor received from the gNB in the WCE for MulteFire system, as in block 1010. The instructions when executed by one or more processors of the UE perform: measuring, at the UE, a channel between the gNB and the UE, as in block 1020. The instructions when executed by one or more processors of the UE perform: calculating, at the UE, a modulation and coding rate based on the channel measurement between the gNB and the UE, as in block 1030. The instructions when executed by one or more processors of the UE perform: scaling, at the UE, the modulation and coding rate using the coding rate scaling factor to form a scaled modulation and coding rate, as in block 1040. The instructions when executed by one or more processors of the UE perform: selecting, at the UE, a CQI index based on the scaled modulation and coding rate, as in block 1050. The instructions when executed by one or more processors of the UE perform: encoding, at the UE, the CQI index for transmission to the gNB in a channel state information (CSI) report, as in block 1060.

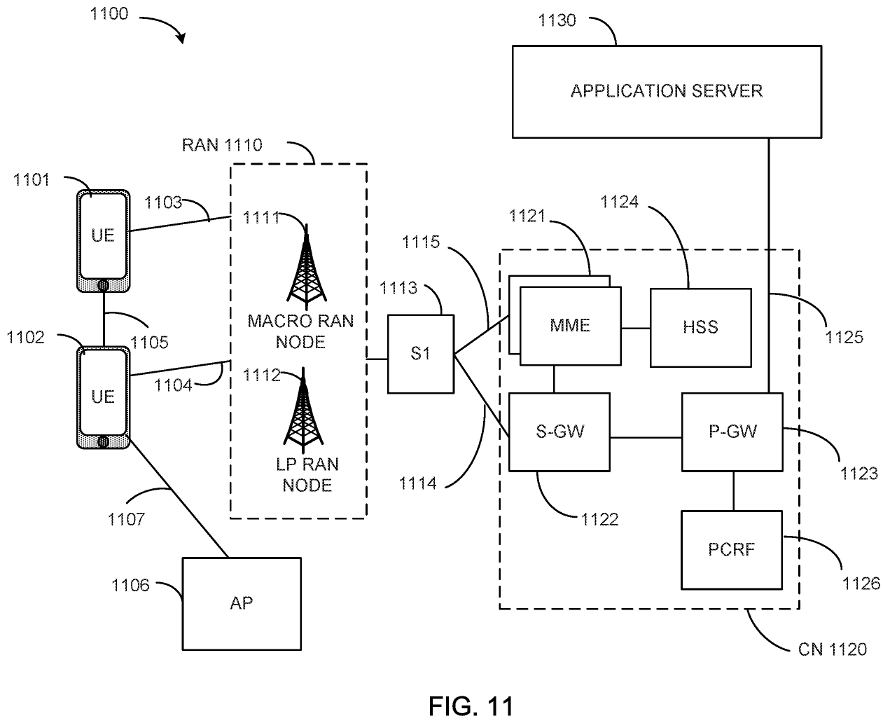

FIG. 11 illustrates an architecture of a system 1100 of a network in accordance with some embodiments. The system 1100 is shown to include a user equipment (UE) 1101 and a UE 1102. The UEs 1101 and 1102 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 1101 and 1102 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 1101 and 1102 may be configured to connect, e.g., communicatively couple, with a radio access network (RAN) 1110—the RAN 1110 may be, for example, an Evolved Universal Mobile Telecommunications System (UMTS) Terrestrial Radio Access Network (E-UTRAN), a NextGen RAN (NG RAN), or some other type of RAN. The UEs 1101 and 1102 utilize connections 1103 and 1104, respectively, each of which comprises a physical communications interface or layer (discussed in further detail below); in this example, the connections 1103 and 1104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 1101 and 1102 may further directly exchange communication data via a ProSe interface 1105. The ProSe interface 1105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1102 is shown to be configured to access an access point (AP) 1106 via connection 1107. The connection 1107 can comprise a local wireless connection, such as a connection consistent with any IEEE 1202.15 protocol, wherein the AP 1106 would comprise a wireless fidelity (WiFi®) router. In this example, the AP 1106 is shown to be connected to the Internet without connecting to the core network of the wireless system (described in further detail below).

The RAN 1110 can include one or more access nodes that enable the connections 1103 and 1104. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 1110 may include one or more RAN nodes for providing macrocells, e.g., macro RAN node 1111, and one or more RAN nodes for providing femtocells or picocells (e.g., cells having smaller coverage areas, smaller user capacity, or higher bandwidth compared to macrocells), e.g., low power (LP) RAN node 1112.

Any of the RAN nodes 1111 and 1112 can terminate the air interface protocol and can be the first point of contact for the UEs 1101 and 1102. In some embodiments, any of the RAN nodes 1111 and 1112 can fulfill various logical functions for the RAN 1110 including, but not limited to, radio network controller (RNC) functions such as radio bearer management, uplink and downlink dynamic radio resource management and data packet scheduling, and mobility management.

In accordance with some embodiments, the UEs 1101 and 1102 can be configured to communicate using Orthogonal Frequency-Division Multiplexing (OFDM) communication signals with each other or with any of the RAN nodes 1111 and 1112 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 1111 and 1112 to the UEs 1101 and 1102, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 1101 and 1102. The physical downlink control channel (PDCCH) may carry information about the transport format and resource allocations related to the PDSCH channel, among other things. It may also inform the UEs 1101 and 1102 about the transport format, resource allocation, and H-ARQ (Hybrid Automatic Repeat Request) information related to the uplink shared channel. Typically, downlink scheduling (assigning control and shared channel resource blocks to the UE 1102 within a cell) may be performed at any of the RAN nodes 1111 and 1112 based on channel quality information fed back from any of the UEs 1101 and 1102. The downlink resource assignment information may be sent on the PDCCH used for (e.g., assigned to) each of the UEs 1101 and 1102.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN 1110 is shown to be communicatively coupled to a core network (CN) 1120—via an S1 interface 1113. In embodiments, the CN 1120 may be an evolved packet core (EPC) network, a NextGen Packet Core (NPC) network, or some other type of CN. In this embodiment the S1 interface 1113 is split into two parts: the S1-U interface 1114, which carries traffic data between the RAN nodes 1111 and 1112 and the serving gateway (S-GW) 1122, and the S1-mobility management entity (MME) interface 1115, which is a signaling interface between the RAN nodes 1111 and 1112 and MMEs 1121.

In this embodiment, the CN 1120 comprises the MMEs 1121, the S-GW 1122, the Packet Data Network (PDN) Gateway (P-GW) 1123, and a home subscriber server (HSS) 1124. The MMEs 1121 may be similar in function to the control plane of legacy Serving General Packet Radio Service (GPRS) Support Nodes (SGSN). The MMEs 1121 may manage mobility aspects in access such as gateway selection and tracking area list management. The HSS 1124 may comprise a database for network users, including subscription-related information to support the network entities' handling of communication sessions. The CN 1120 may comprise one or several HSSs 1124, depending on the number of mobile subscribers, on the capacity of the equipment, on the organization of the network, etc. For example, the HSS 1124 can provide support for routing/roaming, authentication, authorization, naming/addressing resolution, location dependencies, etc.

The S-GW 1122 may terminate the S1 interface 1113 towards the RAN 1110, and routes data packets between the RAN 1110 and the CN 1120. In addition, the S-GW 1122 may be a local mobility anchor point for inter-RAN node handovers and also may provide an anchor for inter-3GPP mobility. Other responsibilities may include lawful intercept, charging, and some policy enforcement.

The P-GW 1123 may terminate an SGi interface toward a PDN. The P-GW 1123 may route data packets between the EPC network 1123 and external networks such as a network including the application server 1130 (alternatively referred to as application function (AF)) via an Internet Protocol (IP) interface 1125. Generally, the application server 1130 may be an element offering applications that use IP bearer resources with the core network (e.g., UMTS Packet Services (PS) domain, LTE PS data services, etc.). In this embodiment, the P-GW 1123 is shown to be communicatively coupled to an application server 1130 via an IP communications interface 1125. The application server 1130 can also be configured to support one or more communication services (e.g., Voice-over-Internet Protocol (VoIP) sessions, PTT sessions, group communication sessions, social networking services, etc.) for the UEs 1101 and 1102 via the CN 1120.

The P-GW 1123 may further be a node for policy enforcement and charging data collection. Policy and Charging Enforcement Function (PCRF) 1126 is the policy and charging control element of the CN 1120. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1126 may be communicatively coupled to the application server 1130 via the P-GW 1123. The application server 1130 may signal the PCRF 1126 to indicate a new service flow and select the appropriate Quality of Service (QoS) and charging parameters. The PCRF 1126 may provision this rule into a Policy and Charging Enforcement Function (PCEF) (not shown) with the appropriate traffic flow template (TFT) and QoS class of identifier (QCI), which commences the QoS and charging as specified by the application server 1130.

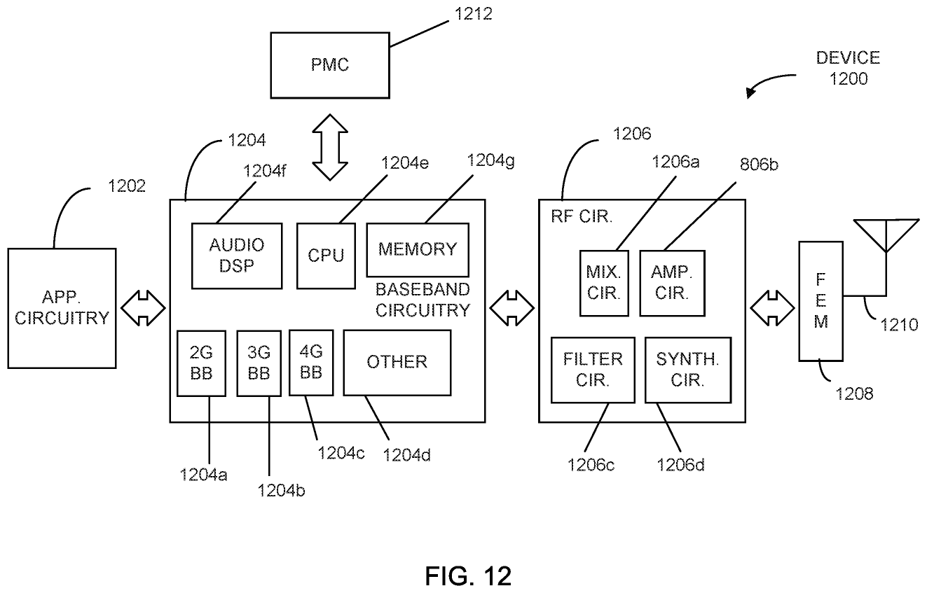

FIG. 12 illustrates example components of a device 1200 in accordance with some embodiments. In some embodiments, the device 1200 may include application circuitry 1202, baseband circuitry 1204, Radio Frequency (RF) circuitry 1206, front-end module (FEM) circuitry 1208, one or more antennas 1210, and power management circuitry (PMC) 1212 coupled together at least as shown. The components of the illustrated device 1200 may be included in a UE or a RAN node. In some embodiments, the device 1200 may include less elements (e.g., a RAN node may not utilize application circuitry 1202, and instead include a processor/controller to process IP data received from an EPC). In some embodiments, the device 1200 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 1202 may include one or more application processors. For example, the application circuitry 1202 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1200. In some embodiments, processors of application circuitry 1202 may process IP data packets received from an EPC.

The baseband circuitry 1204 may include circuitry such as, but not limited to, one or more single-core or multi-core processors. The baseband circuitry 1204 may include one or more baseband processors or control logic to process baseband signals received from a receive signal path of the RF circuitry 1206 and to generate baseband signals for a transmit signal path of the RF circuitry 1206. Baseband processing circuitry 1204 may interface with the application circuitry 1202 for generation and processing of the baseband signals and for controlling operations of the RF circuitry 1206. For example, in some embodiments, the baseband circuitry 1204 may include a third generation (3G) baseband processor 1204a, a fourth generation (4G) baseband processor 1204b, a fifth generation (5G) baseband processor 1204c, or other baseband processor(s) 1204d for other existing generations, generations in development or to be developed in the future (e.g., second generation (2G), sixth generation (6G), etc.). The baseband circuitry 1204 (e.g., one or more of baseband processors 1204a-d) may handle various radio control functions that enable communication with one or more radio networks via the RF circuitry 1206. In other embodiments, some or all of the functionality of baseband processors 1204a-d may be included in modules stored in the memory 1204g and executed via a Central Processing Unit (CPU) 1204e. The radio control functions may include, but are not limited to, signal modulation/demodulation, encoding/decoding, radio frequency shifting, etc. In some embodiments, modulation/demodulation circuitry of the baseband circuitry 1204 may include Fast-Fourier Transform (FFT), precoding, or constellation mapping/demapping functionality. In some embodiments, encoding/decoding circuitry of the baseband circuitry 1204 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1204 may include one or more audio digital signal processor(s) (DSP) 1204f. The audio DSP(s) 1204f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 1204 and the application circuitry 1202 may be implemented together such as, for example, on a system on a chip (SOC).

In some embodiments, the baseband circuitry 1204 may provide for communication compatible with one or more radio technologies. For example, in some embodiments, the baseband circuitry 1204 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 1204 is configured to support radio communications of more than one wireless protocol may be referred to as multi-mode baseband circuitry.

RF circuitry 1206 may enable communication with wireless networks using modulated electromagnetic radiation through a non-solid medium. In various embodiments, the RF circuitry 1206 may include switches, filters, amplifiers, etc. to facilitate the communication with the wireless network. RF circuitry 1206 may include a receive signal path which may include circuitry to down-convert RF signals received from the FEM circuitry 1208 and provide baseband signals to the baseband circuitry 1204. RF circuitry 1206 may also include a transmit signal path which may include circuitry to up-convert baseband signals provided by the baseband circuitry 1204 and provide RF output signals to the FEM circuitry 1208 for transmission.

In some embodiments, the receive signal path of the RF circuitry 1206 may include mixer circuitry 1206a, amplifier circuitry 1206b and filter circuitry 1206c. In some embodiments, the transmit signal path of the RF circuitry 1206 may include filter circuitry 1206c and mixer circuitry 1206a. RF circuitry 1206 may also include synthesizer circuitry 1206d for synthesizing a frequency for use by the mixer circuitry 1206a of the receive signal path and the transmit signal path. In some embodiments, the mixer circuitry 1206a of the receive signal path may be configured to down-convert RF signals received from the FEM circuitry 1208 based on the synthesized frequency provided by synthesizer circuitry 1206d. The amplifier circuitry 1206b may be configured to amplify the down-converted signals and the filter circuitry 1206c may be a low-pass filter (LPF) or band-pass filter (BPF) configured to remove unwanted signals from the down-converted signals to generate output baseband signals. Output baseband signals may be provided to the baseband circuitry 1204 for further processing. In some embodiments, the output baseband signals may be zero-frequency baseband signals, although this is not a necessity. In some embodiments, mixer circuitry 1206a of the receive signal path may comprise passive mixers, although the scope of the embodiments is not limited in this respect.

In some embodiments, the mixer circuitry 1206a of the transmit signal path may be configured to up-convert input baseband signals based on the synthesized frequency provided by the synthesizer circuitry 1206d to generate RF output signals for the FEM circuitry 1208. The baseband signals may be provided by the baseband circuitry 1204 and may be filtered by filter circuitry 1206c.

In some embodiments, the mixer circuitry 1206a of the receive signal path and the mixer circuitry 1206a of the transmit signal path may include two or more mixers and may be arranged for quadrature downconversion and upconversion, respectively. In some embodiments, the mixer circuitry 1206a of the receive signal path and the mixer circuitry 1206a of the transmit signal path may include two or more mixers and may be arranged for image rejection (e.g., Hartley image rejection). In some embodiments, the mixer circuitry 1206a of the receive signal path and the mixer circuitry 1206a may be arranged for direct downconversion and direct upconversion, respectively. In some embodiments, the mixer circuitry 1206a of the receive signal path and the mixer circuitry 1206a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1206 may include analog-to-digital converter (ADC) and digital-to-analog converter (DAC) circuitry and the baseband circuitry 1204 may include a digital baseband interface to communicate with the RF circuitry 1206.

In some dual-mode embodiments, a separate radio IC circuitry may be provided for processing signals for each spectrum, although the scope of the embodiments is not limited in this respect.

In some embodiments, the synthesizer circuitry 1206d may be a fractional-N synthesizer or a fractional N/N+1 synthesizer, although the scope of the embodiments is not limited in this respect as other types of frequency synthesizers may be suitable. For example, synthesizer circuitry 1206d may be a delta-sigma synthesizer, a frequency multiplier, or a synthesizer comprising a phase-locked loop with a frequency divider.

The synthesizer circuitry 1206d may be configured to synthesize an output frequency for use by the mixer circuitry 1206a of the RF circuitry 1206 based on a frequency input and a divider control input. In some embodiments, the synthesizer circuitry 1206d may be a fractional N/N+1 synthesizer.

In some embodiments, frequency input may be provided by a voltage controlled oscillator (VCO), although that is not a necessity. Divider control input may be provided by either the baseband circuitry 1204 or the applications processor 1202 depending on the desired output frequency. In some embodiments, a divider control input (e.g., N) may be determined from a look-up table based on a channel indicated by the applications processor 1202.

Synthesizer circuitry 1206d of the RF circuitry 1206 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 1206d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 1206 may include an IQ/polar converter.

FEM circuitry 1208 may include a receive signal path which may include circuitry configured to operate on RF signals received from one or more antennas 1210, amplify the received signals and provide the amplified versions of the received signals to the RF circuitry 1206 for further processing. FEM circuitry 1208 may also include a transmit signal path which may include circuitry configured to amplify signals for transmission provided by the RF circuitry 1206 for transmission by one or more of the one or more antennas 1210. In various embodiments, the amplification through the transmit or receive signal paths may be done solely in the RF circuitry 1206, solely in the FEM 1208, or in both the RF circuitry 1206 and the FEM 1208.

In some embodiments, the FEM circuitry 1208 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 1206). The transmit signal path of the FEM circuitry 1208 may include a power amplifier (PA) to amplify input RF signals (e.g., provided by RF circuitry 1206), and one or more filters to generate RF signals for subsequent transmission (e.g., by one or more of the one or more antennas 1210).

In some embodiments, the PMC 1212 may manage power provided to the baseband circuitry 1204. In particular, the PMC 1212 may control power-source selection, voltage scaling, battery charging, or DC-to-DC conversion. The PMC 1212 may often be included when the device 1200 is capable of being powered by a battery, for example, when the device is included in a UE. The PMC 1212 may increase the power conversion efficiency while providing desirable implementation size and heat dissipation characteristics.

While FIG. 12 shows the PMC 1212 coupled only with the baseband circuitry 1204. However, in other embodiments, the PMC 1212 may be additionally or alternatively coupled with, and perform similar power management operations for, other components such as, but not limited to, application circuitry 1202, RF circuitry 1206, or FEM 1208.

In some embodiments, the PMC 1212 may control, or otherwise be part of, various power saving mechanisms of the device 1200. For example, if the device 1200 is in an RRC_Connected state, where it is still connected to the RAN node as it expects to receive traffic shortly, then it may enter a state known as Discontinuous Reception Mode (DRX) after a period of inactivity. During this state, the device 1200 may power down for brief intervals of time and thus save power.

If there is no data traffic activity for an extended period of time, then the device 1200 may transition off to an RRC Idle state, where it disconnects from the network and does not perform operations such as channel quality feedback, handover, etc. The device 1200 goes into a very low power state and it performs paging where again it periodically wakes up to listen to the network and then powers down again. The device 1200 may not receive data in this state, in order to receive data, it can transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 1202 and processors of the baseband circuitry 1204 may be used to execute elements of one or more instances of a protocol stack. For example, processors of the baseband circuitry 1204, alone or in combination, may be used execute Layer 3, Layer 2, or Layer 1 functionality, while processors of the application circuitry 1204 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

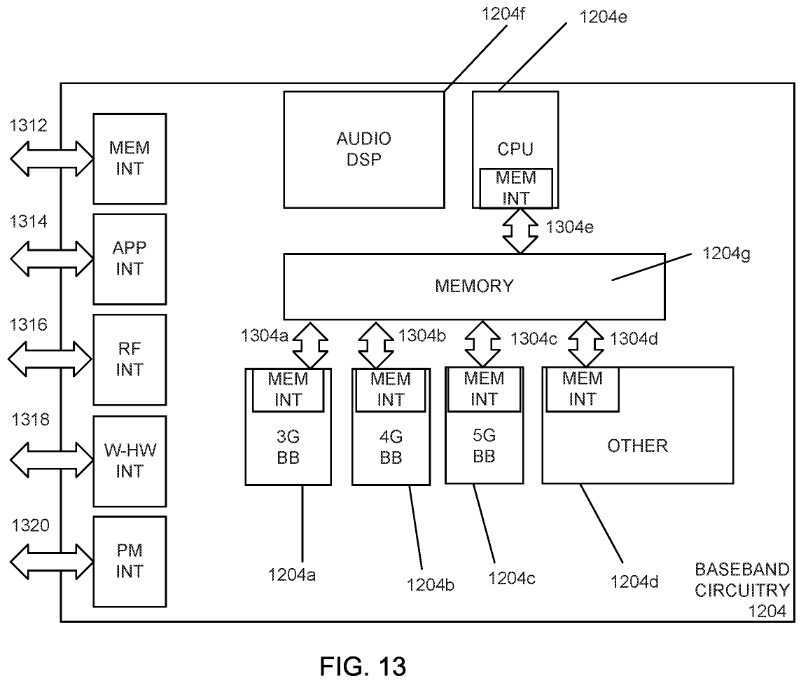

FIG. 13 illustrates example interfaces of baseband circuitry in accordance with some embodiments. As discussed above, the baseband circuitry 1204 of FIG. 12 may comprise processors 1204a-1204e and a memory 1204g utilized by said processors. Each of the processors 1204a-1204e may include a memory interface, 1304a-1304e, respectively, to send/receive data to/from the memory 1204g.

The baseband circuitry 1204 may further include one or more interfaces to communicatively couple to other circuitries/devices, such as a memory interface 1312 (e.g., an interface to send/receive data to/from memory external to the baseband circuitry 1204), an application circuitry interface 1314 (e.g., an interface to send/receive data to/from the application circuitry 1202 of FIG. 12), an RF circuitry interface 1316 (e.g., an interface to send/receive data to/from RF circuitry 1206 of FIG. 12), a wireless hardware connectivity interface 1318 (e.g., an interface to send/receive data to/from Near Field Communication (NFC) components, Bluetooth® components (e.g., Bluetooth® Low Energy), Wi-Fi® components, and other communication components), and a power management interface 1320 (e.g., an interface to send/receive power or control signals to/from the PMC 1212.

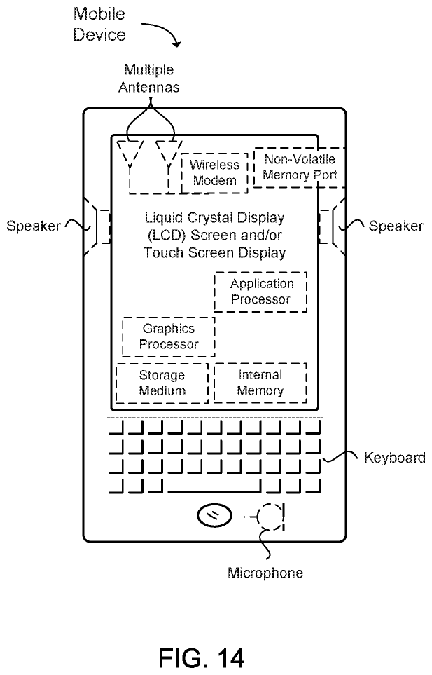

FIG. 14 provides an example illustration of the wireless device, such as a user equipment (UE), a mobile station (MS), a mobile wireless device, a mobile communication device, a tablet, a handset, or other type of wireless device. The wireless device can include one or more antennas configured to communicate with a node, macro node, low power node (LPN), or, transmission station, such as a base station (BS), an evolved Node B (eNB), a baseband processing unit (BBU), a remote radio head (RRH), a remote radio equipment (RRE), a relay station (RS), a radio equipment (RE), or other type of wireless wide area network (WWAN) access point. The wireless device can be configured to communicate using at least one wireless communication standard such as, but not limited to, 3GPP LTE, WiMAX, High Speed Packet Access (HSPA), Bluetooth, and WiFi. The wireless device can communicate using separate antennas for each wireless communication standard or shared antennas for multiple wireless communication standards. The wireless device can communicate in a wireless local area network (WLAN), a wireless personal area network (WPAN), and/or a WWAN. The wireless device can also comprise a wireless modem. The wireless modem can comprise, for example, a wireless radio transceiver and baseband circuitry (e.g., a baseband processor). The wireless modem can, in one example, modulate signals that the wireless device transmits via the one or more antennas and demodulate signals that the wireless device receives via the one or more antennas.

FIG. 14 also provides an illustration of a microphone and one or more speakers that can be used for audio input and output from the wireless device. The display screen can be a liquid crystal display (LCD) screen, or other type of display screen such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the wireless device. A keyboard can be integrated with the wireless device or wirelessly connected to the wireless device to provide additional user input. A virtual keyboard can also be provided using the touch screen.

### EXAMPLES

The following examples pertain to specific technology embodiments and point out specific features, elements, or actions that can be used or otherwise combined in achieving such embodiments.

Example 1 includes an apparatus of a user equipment (UE) operable to report channel quality indication (CQI) information to a Next Generation NodeB (gNB) in a wideband coverage enhancement (WCE) for MulteFire system, the apparatus comprising: one or more processors configured to: decode, at the UE, a coding rate scaling factor received from the gNB in the WCE for MulteFire system; measure, at the UE, a channel between the gNB and the UE; calculate, at the UE, a modulation and coding rate based on the channel measurement between the gNB and the UE; scale, at the UE, the modulation and coding rate using the coding rate scaling factor to form a scaled modulation and coding rate; select, at the UE, a CQI index that corresponds to the scaled modulation and coding rate; and encode, at the UE, the CQI index for transmission to the gNB in a channel state information (CSI) report; and a memory interface configured to send to a memory the coding rate scaling factor.

Example 2 includes the apparatus of Example 1, further comprising a transceiver configured to: receive the coding rate scaling factor from the gNB; and transmit the CQI index to the gNB in the CSI report.

Example 3 includes the apparatus of any of Examples 1 to 2, wherein the one or more processors are further configured to decode the coding rate scaling factor received from the gNB via higher layer signaling between the gNB and the UE.

Example 4 includes the apparatus of any of Examples 1 to 2, wherein the one or more processors are further configured to select the CQI index using a CQI table, comprising:

| | | code rate × | |
|---|---|---|---|
| CQI | | 1024 × | efficiency × |
| index | modulation | R_CSI | R_CSI |
| 0 | out of range | | |
| 1 | QPSK | 40 | 0.0781 |
| 2 | QPSK | 78 | 0.1523 |
| 3 | QPSK | 120 | 0.2344 |
| 4 | QPSK | 193 | 0.3770 |
| 5 | QPSK | 308 | 0.6016 |
| 6 | QPSK | 449 | 0.8770 |
| 7 | QPSK | 602 | 1.1758 |
| 8 | 16QAM | 378 | 1.4766 |
| 9 | 16QAM | 490 | 1.9141 |
| 10 | 16QAM | 616 | 2.4063 |
| 11 | 64QAM | 466 | 2.7305 |
| 12 | 64QAM | 567 | 3.3223 |
| 13 | 64QAM | 666 | 3.9023 |
| 14 | 64QAM | 772 | 4.5234 |
| 15 | 64QAM | 873 | 5.1152, |

where R_CSI is the coding rate scaling factor which accounts for a number of time domain repetitions and transport block size (TBS) scaling used by the gNB to enhance coverage.

Example 5 includes the apparatus of any of Examples 1 to 4, wherein the one or more processors are further configured to select the CQI index using a CQI table, wherein the CQI table includes a listing of CQI indexes from 1 to 15, and for each CQI index, a modulation scheme, a modulation and coding rate multiplied by 1024 and the coding rate scaling factor, and a spectral efficiency value multiplied by the coding rate scaling factor.

Example 6 includes the apparatus of any of Examples 1 to 5, wherein the coding rate scaling factor is configured based on a number of time domain repetitions and transport block size (TBS) scaling.

Example 7 includes an apparatus of a Next Generation NodeB (gNB) operable to decode channel quality indication (CQI) information received from a user equipment (UE) in a wideband coverage enhancement (WCE) for MulteFire system, the apparatus comprising: one or more processors configured to: encode, at the gNB, a coding rate scaling factor for transmission to the UE in the WCE for MulteFire system; and decode, at the gNB, a CQI index received in a channel state information (CSI) report from the UE in the WCE for MulteFire system, wherein the CQI index corresponds to a scaled modulation and coding rate based on the coding rate scaling factor; and a memory interface configured to send to a memory the CQI index received from the UE.

Example 8 includes the apparatus of Example 7, further comprising a transceiver configured to: transmit the coding rate scaling factor to the UE; and receive the CQI index in the CSI report from the UE.

Example 9 includes the apparatus of any of Examples 7 to 8, wherein the one or more processors are further configured to encode the coding rate scaling factor for transmission to the UE via radio resource control (RRC) signaling between the gNB and the UE.

Example 10 includes the apparatus of any of Examples 7 to 9, wherein the coding rate scaling factor is cell-specific or UE specific.

Example 11 includes the apparatus of any of Examples 7 to 10, wherein the coding rate scaling factor is configured based on a number of time domain repetitions and transport block size (TBS) scaling.

Example 12 includes the apparatus of any of Examples 7 to 11, wherein the one or more processors are further configured to perform a downlink transmission with the UE that is enhanced using time domain repetitions and transport block size (TBS) scaling.

Example 13 includes the apparatus of any of Examples 7 to 12, wherein the coding rate scaling factor is configured based on one or more of: a number of time domain repetitions, transport block size (TBS) scaling, a number of frequency domain repetitions or a power boosting factor.

Example 14 includes at least one machine readable storage medium having instructions embodied thereon for reporting channel quality indication (CQI) information from a user equipment (UE) to a Next Generation NodeB (gNB) in a wideband coverage enhancement (WCE) for MulteFire system, the instructions when executed by one or more processors of the UE perform the following: decoding, at the UE, a coding rate scaling factor received from the gNB in the WCE for MulteFire system; measuring, at the UE, a channel between the gNB and the UE; calculating, at the UE, a modulation and coding rate based on the channel measurement between the gNB and the UE; scaling, at the UE, the modulation and coding rate using the coding rate scaling factor to form a scaled modulation and coding rate; selecting, at the UE, a CQI index based on the scaled modulation and coding rate; and encoding, at the UE, the CQI index for transmission to the gNB in a channel state information (CSI) report.

Example 15 includes the at least one machine readable storage medium of Example 14, further comprising instructions when executed perform the following: decoding the coding rate scaling factor received from the gNB via radio resource control (RRC) signaling between the gNB and the UE.

Example 16 includes the at least one machine readable storage medium of any of Examples 14 to 15, wherein the coding rate scaling factor is cell-specific or UE specific.

Example 17 includes the at least one machine readable storage medium of any of Examples 14 to 16, further comprising instructions when executed perform the following: selecting the CQI index using a CQI table, comprising:

| | | code rate × | |
|---|---|---|---|
| CQI | | 1024 × | efficiency × |
| index | modulation | R_CSI | R_CSI |
| 0 | out of range | | |
| 1 | QPSK | 40 | 0.0781 |
| 2 | QPSK | 78 | 0.1523 |
| 3 | QPSK | 120 | 0.2344 |
| 4 | QPSK | 193 | 0.3770 |
| 5 | QPSK | 308 | 0.6016 |
| 6 | QPSK | 449 | 0.8770 |
| 7 | QPSK | 602 | 1.1758 |
| 8 | 16QAM | 378 | 1.4766 |
| 9 | 16QAM | 490 | 1.9141 |
| 10 | 16QAM | 616 | 2.4063 |
| 11 | 64QAM | 466 | 2.7305 |
| 12 | 64QAM | 567 | 3.3223 |
| 13 | 64QAM | 666 | 3.9023 |
| 14 | 64QAM | 772 | 4.5234 |
| 15 | 64QAM | 873 | 5.1152, |

where R_CSI is the coding rate scaling factor which accounts for a number of time domain repetitions and transport block size (TBS) scaling used by the gNB to enhance coverage.

Example 18 includes the at least one machine readable storage medium of any of Examples 14 to 17, further comprising instructions when executed perform the following: selecting the CQI index using a CQI table, wherein the CQI table includes a listing of CQI indexes from 1 to 15, and for each CQI index, a modulation scheme, a modulation and coding rate multiplied by 1024 and the coding rate scaling factor, and a spectral efficiency value multiplied by the coding rate scaling factor.

Example 19 includes the at least one machine readable storage medium of any of Examples 14 to 18, wherein the coding rate scaling factor is configured based on a number of time domain repetitions and transport block size (TBS) scaling.

Example 20 includes the at least one machine readable storage medium of any of Examples 14 to 19, wherein the coding rate scaling factor is configured based on one or more of: a number of time domain repetitions, transport block size (TBS) scaling, a number of frequency domain repetitions or a power boosting factor.

Example 21 includes a user equipment (UE) operable to report channel quality indication (CQI) information to a Next Generation NodeB (gNB) in a wideband coverage enhancement (WCE) for MulteFire system, the UE comprising: means for decoding, at the UE, a coding rate scaling factor received from the gNB in the WCE for MulteFire system; means for measuring, at the UE, a channel between the gNB and the UE; means for calculating, at the UE, a modulation and coding rate based on the channel measurement between the gNB and the UE; means for scaling, at the UE, the modulation and coding rate using the coding rate scaling factor to form a scaled modulation and coding rate; means for selecting, at the UE, a CQI index based on the scaled modulation and coding rate; and means for encoding, at the UE, the CQI index for transmission to the gNB in a channel state information (CSI) report.

Example 22 includes the UE of Example 21, further comprising: means for decoding the coding rate scaling factor received from the gNB via radio resource control (RRC) signaling between the gNB and the UE.

Example 23 includes the UE of any of Examples 21 to 22, wherein the coding rate scaling factor is cell-specific or UE specific.

Example 24 includes the UE of any of Examples 21 to 23, further comprising: means for selecting the CQI index using a CQI table, comprising:

| | | code rate × | |
|---|---|---|---|
| CQI | | 1024 × | efficiency × |
| index | modulation | R_CSI | R_CSI |
| 0 | out of range | | |
| 1 | QPSK | 40 | 0.0781 |
| 2 | QPSK | 78 | 0.1523 |
| 3 | QPSK | 120 | 0.2344 |
| 4 | QPSK | 193 | 0.3770 |
| 5 | QPSK | 308 | 0.6016 |
| 6 | QPSK | 449 | 0.8770 |
| 7 | QPSK | 602 | 1.1758 |
| 8 | 16QAM | 378 | 1.4766 |
| 9 | 16QAM | 490 | 1.9141 |
| 10 | 16QAM | 616 | 2.4063 |
| 11 | 64QAM | 466 | 2.7305 |
| 12 | 64QAM | 567 | 3.3223 |
| 13 | 64QAM | 666 | 3.9023 |
| 14 | 64QAM | 772 | 4.5234 |
| 15 | 64QAM | 873 | 5.1152, |

where R_CSI is the coding rate scaling factor which accounts for a number of time domain repetitions and transport block size (TBS) scaling used by the gNB to enhance coverage.

Example 25 includes the UE of any of Examples 21 to 24, further comprising: means for selecting the CQI index using a CQI table, wherein the CQI table includes a listing of CQI indexes from 1 to 15, and for each CQI index, a modulation scheme, a modulation and coding rate multiplied by 1024 and the coding rate scaling factor, and a spectral efficiency value multiplied by the coding rate scaling factor.

Example 26 includes the UE of any of Examples 21 to 25, wherein the coding rate scaling factor is configured based on a number of time domain repetitions and transport block size (TBS) scaling.

Example 27 includes the UE of any of Examples 21 to 26, wherein the coding rate scaling factor is configured based on one or more of: a number of time domain repetitions, transport block size (TBS) scaling, a number of frequency domain repetitions or a power boosting factor.

Various techniques, or certain aspects or portions thereof, may take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). In one example, selected components of the transceiver module can be located in a cloud radio access network (C-RAN). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

It should be understood that many of the functional units described in this specification have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module may not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” or “exemplary” means that a particular feature, structure, or characteristic described in connection with the example is included in at least one embodiment of the present technology. Thus, appearances of the phrases “in an example” or the word “exemplary” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present technology may be referred to herein along with alternatives for the various components thereof. It is understood that such embodiments, examples, and alternatives are not to be construed as defacto equivalents of one another, but are to be considered as separate and autonomous representations of the present technology.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the technology. One skilled in the relevant art will recognize, however, that the technology can be practiced without one or more of the specific details, or with other methods, components, layouts, etc. In other instances, well-known structures, materials, or operations are not shown or described in detail to avoid obscuring aspects of the technology.

While the forgoing examples are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology.

What is claimed is:

1-20. (canceled)

21. An apparatus of a MulteFire (MF) wideband coverage enhancement (WCE) user equipment (UE) operable to report channel quality indication (CQI) information to a base station, the apparatus comprising:
one or more processors configured to:
decode, at the MF WCE UE, a coding rate scaling factor received from the base station;
calculate, at the UE, a modulation and coding rate based on a channel measurement between the base station and the MF WCE UE;
scale, at the UE, the modulation and coding rate using the coding rate scaling factor to form a scaled modulation and coding rate;
select, at the UE, a CQI index that corresponds to the scaled modulation and coding rate; and
encode, at the UE, the CQI index for transmission to the base station; and
a memory interface configured to send to a memory the coding rate scaling factor.

22. The apparatus of claim 21, further comprising a transceiver configured to:
receive the coding rate scaling factor from the base station; and
transmit the CQI index to the base station.

23. The apparatus of claim 21, wherein the one or more processors are further configured to decode the coding rate scaling factor received from the base station via higher layer signaling between the base station and the UE.

24. The apparatus of claim 21, wherein the one or more processors are further configured to select the CQI index using a CQI table, comprising:

| | | code rate × 1024 × | efficiency × |
|---|---|---|---|
| | | coding rate scaling | coding rate |
| CQI index | modulation | factor | scaling factor |
| 0 | out of range | | |
| 1 | QPSK | 40 | 0.0781 |
| 2 | QPSK | 78 | 0.1523 |
| 3 | QPSK | 120 | 0.2344 |
| 4 | QPSK | 193 | 0.3770 |
| 5 | QPSK | 308 | 0.6016 |
| 6 | QPSK | 449 | 0.8770 |
| 7 | QPSK | 602 | 1.1758 |
| 8 | 16QAM | 378 | 1.4766 |
| 9 | 16QAM | 490 | 1.9141 |
| 10 | 16QAM | 616 | 2.4063 |
| 11 | 64QAM | 466 | 2.7305 |
| 12 | 64QAM | 567 | 3.3223 |
| 13 | 64QAM | 666 | 3.9023 |
| 14 | 64QAM | 772 | 4.5234 |
| 15 | 64QAM | 873 | 5.1152 |

25. The apparatus of claim 21, wherein the one or more processors are further configured to select the CQI index using a CQI table, wherein the CQI table includes a listing of CQI indexes from 1 to 15, and for each CQI index, a modulation scheme, a modulation and coding rate multiplied by 1024 and the coding rate scaling factor, and an efficiency value multiplied by the coding rate scaling factor.

26. The apparatus of claim 21, wherein the coding rate scaling factor is configured based on a number of time domain repetitions and transport block size (TBS) scaling.

27. An apparatus of a Next Generation NodeB (gNB) operable to decode channel quality indication (CQI) information received from a user equipment (UE) in a wideband coverage enhancement (WCE) for MulteFire system, the apparatus comprising:
one or more processors configured to:
encode, at the gNB, a coding rate scaling factor for transmission to the UE in the WCE for MulteFire system; and
decode, at the gNB, a CQI index received in a channel state information (CSI) report from the UE in the WCE for MulteFire system, wherein the CQI index corresponds to a scaled modulation and coding rate based on the coding rate scaling factor; and
a memory interface configured to send to a memory the CQI index received from the UE.

28. The apparatus of claim 27, further comprising a transceiver configured to:
transmit the coding rate scaling factor to the UE; and
receive the CQI index in the CSI report from the UE.

29. The apparatus of claim 27, wherein the one or more processors are further configured to encode the coding rate scaling factor for transmission to the UE via radio resource control (RRC) signaling between the gNB and the UE.

30. The apparatus of claim 27, wherein the coding rate scaling factor is cell-specific or UE specific.

31. The apparatus of claim 27, wherein the coding rate scaling factor is configured based on a number of time domain repetitions and transport block size (TBS) scaling.

32. The apparatus of claim 27, wherein the one or more processors are further configured to perform a downlink transmission with the UE that is enhanced using time domain repetitions and transport block size (TBS) scaling.

33. The apparatus of claim 27, wherein the coding rate scaling factor is configured based on one or more of: a number of time domain repetitions, transport block size (TBS) scaling, a number of frequency domain repetitions or a power boosting factor.

34. At least one non-transitory machine readable storage medium having instructions embodied thereon for reporting channel quality indication (CQI) information from a user equipment (UE) to a Next Generation NodeB (gNB) in a wideband coverage enhancement (WCE) for MulteFire system, the instructions when executed by one or more processors of the UE perform the following:
decoding, at the UE, a coding rate scaling factor received from the gNB in the WCE for MulteFire system;
measuring, at the UE, a channel between the gNB and the UE;
calculating, at the UE, a modulation and coding rate based on the channel measurement between the gNB and the UE;
scaling, at the UE, the modulation and coding rate using the coding rate scaling factor to form a scaled modulation and coding rate;
selecting, at the UE, a CQI index based on the scaled modulation and coding rate; and
encoding, at the UE, the CQI index for transmission to the gNB in a channel state information (CSI) report.

35. The at least one non-transitory machine readable storage medium of claim 34, further comprising instructions when executed perform the following: decoding the coding rate scaling factor received from the gNB via radio resource control (RRC) signaling between the gNB and the UE.

36. The at least one non-transitory machine readable storage medium of claim 34, wherein the coding rate scaling factor is cell-specific or UE specific.

37. The at least one non-transitory machine readable storage medium of claim 34, further comprising instructions when executed perform the following: selecting the CQI index using a CQI table, comprising:

| | | code rate × 1024 × | efficiency × |
|---|---|---|---|
| CQI index | modulation | R_CSI | R_CSI |
| 0 | out of range | | |
| 1 | QPSK | 40 | 0.0781 |
| 2 | QPSK | 78 | 0.1523 |
| 3 | QPSK | 120 | 0.2344 |
| 4 | QPSK | 193 | 0.3770 |
| 5 | QPSK | 308 | 0.6016 |
| 6 | QPSK | 449 | 0.8770 |
| 7 | QPSK | 602 | 1.1758 |
| 8 | 16QAM | 378 | 1.4766 |
| 9 | 16QAM | 490 | 1.9141 |
| 10 | 16QAM | 616 | 2.4063 |
| 11 | 64QAM | 466 | 2.7305 |
| 12 | 64QAM | 567 | 3.3223 |
| 13 | 64QAM | 666 | 3.9023 |
| 14 | 64QAM | 772 | 4.5234 |
| 15 | 64QAM | 873 | 5.1152, |

where R_CSI is the coding rate scaling factor which accounts for a number of time domain repetitions and transport block size (TBS) scaling used by the gNB to enhance coverage.

38. The at least one non-transitory machine readable storage medium of claim 34, further comprising instructions when executed perform the following: selecting the CQI index using a CQI table, wherein the CQI table includes a listing of CQI indexes from 1 to 15, and for each CQI index, a modulation scheme, a modulation and coding rate multiplied by 1024 and the coding rate scaling factor, and a spectral efficiency value multiplied by the coding rate scaling factor.

39. The at least one non-transitory machine readable storage medium of claim 34, wherein the coding rate scaling factor is configured based on a number of time domain repetitions and transport block size (TBS) scaling.

40. The at least one non-transitory machine readable storage medium of claim 34, wherein the coding rate scaling factor is configured based on one or more of: a number of time domain repetitions, transport block size (TBS) scaling, a number of frequency domain repetitions or a power boosting factor.
